(19) United States
(12) Patent Application Publication
(10) Pub. No.: US 2007/0136606 A1
(43) Pub. Date: Jun. 14, 2007

(54) Storage system with built-in encryption function

(76) Inventor: Makio Mizuno, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/354,050

(22) Filed: Feb. 15, 2006

(30) Foreign Application Priority Data
Dec. 8, 2005 (JP) 2005-354806

(51) Int. Cl. H04L 9/00; G06F 12/14; H04L 9/32; G06F 11/30

(52) U.S. Cl. 713/189; 380/284; 713/150; 713/151; 713/152; 713/193; 713/192

(57) ABSTRACT

In a plurality of storage systems including data encryption functions, there is a possibility that encryption keys necessary for data encryption and decryption may differ among the storage systems. Provided is a computer system including one or more host computers and a plurality of storage controllers connected to the host computer, in which the storage controller encrypts data by using a first encryption key upon reception of a writing request of the data from the host computer, stores the encrypted data and the first encryption key in the storage device, reads the encrypted data and the first encryption key from the storage device upon reception of a reading request of the data from the host computer, and decrypts the encrypted data by using the read first encryption key.

### CLAIM OF PRIORITY

The present application claims priority from Japanese application JP2005-354806 filed on Dec. 8, 2005, the content of which is hereby incorporated by reference into this application.

### BACKGROUND

The technology disclosed in this specification relates to a storage system for encrypting/decrypting data, and more particularly to a key management method used for the encryption/decryption.

It has recently been imperative to take security measures for a storage system. One of such measures is a data encryption technology described in JP 2002-217887 A. An encryption key is always necessary for encrypting data, and the data cannot be correctly decrypted without using the encryption key (or decryption key corresponding to the encryption key). Accordingly, the data decrypted without using the encryption key turns into a bit string totally meaningless to a user or an application, with the result that those who don't know the encryption key cannot use the encrypted data. Therefore, security of the encrypted data is assured.

Additionally, a virtualization technology of a storage system has made progress. According to this technology, it is possible to integrally manage and run a plurality of dispersed storage systems as a single storage system image, which is expected to reduce a processing load of the storage system which is otherwise a bottleneck in performance as well as a load on a system administrator. For example, when data processing loads are concentrated in a controller of a given storage system, the processing can be dispersed to controllers of other storage systems to balance the loads.

### SUMMARY

According to the above-described security trend, a data encryption technology may be applied to the storage system in the future. However, in light of the progress in the virtualization technology of the storage system, there arises a problem when the data encryption technology is merely applied to the storage system. In other words, in the plurality of storage systems including data encryption functions, there may be a case where encryption keys necessary for data encryption and decryption may differ among the storage systems. In such a case, for example, when data written via a given controller is read through another controller, the read data is not correctly decrypted if the two controllers use different encryption keys.

A representative invention disclosed in this application includes a computer system including one or more host computers and a plurality of storage controllers coupled to the host computer through a first network, in which the host computer includes: a first interface coupled to the first network; a first processor coupled to the first interface; and a first memory coupled to the first processor, each of the storage controllers is coupled to a storage device which stores data and includes one or more second processors and one or more second memories coupled to the second processors, and the second processor encrypts data by using a first encryption key upon reception of a writing request of the data from the host computer, stores the encrypted data and the first encryption key in the storage device, reads the encrypted data and the first encryption key from the storage device upon reception of a reading request of the data from the host computer, and decrypts the encrypted data by using the read first encryption key.

According to an embodiment of this invention, the data can be correctly decrypted even when a controller which has written data and a controller which has read the data are different from each other in an environment where a plurality of controllers are authorized to access one volume.

### BRIEF DESCRIPTION OF THE DRAWINGS

FIG. 1A is a block diagram showing a configuration of a computer system according to a first embodiment of this invention.

FIG. 1B is an explanatory diagram of a memory installed in a host I/F control part according to the first embodiment of this invention.

FIG. 1C is an explanatory diagram of a memory installed in a disk I/F control part according to the first embodiment of this invention.

FIG. 2 is an explanatory diagram showing an example of a volume management table according to the first embodiment of this invention.

FIG. 3 is a flowchart showing a process executed by a storage controller in response to a data writing request from a host computer according to the first embodiment of this invention.

FIG. 4 is a flowchart showing a process executed by the storage controller in response to a data reading request from the host computer according to the first embodiment of this invention.

FIG. 5A is a block diagram showing a configuration of a computer system according to a second embodiment of this invention.

FIG. 5B is an explanatory diagram of a memory installed in a management terminal according to the second embodiment of this invention.

FIG. 6 is an explanatory diagram of a process where the management server delivers a key encryption key according to the second embodiment of this invention.

FIG. 7 is an explanatory diagram of a process executed when a storage controller is prohibited from accessing a data volume according to the second embodiment of this invention.

FIG. 8 is an explanatory diagram of another process executed when the storage controller is prohibited from accessing the data volume according to the second embodiment of this invention.

FIG. 9 is an explanatory diagram of further another process executed when the storage controller is prohibited from accessing the data volume according to the second embodiment of this invention.

FIG. 10 is an explanatory diagram of a still further process executed when the storage controller is prohibited from accessing the data volume according to the second embodiment of this invention.

### DESCRIPTION OF THE PREFERRED EMBODIMENTS

The preferred embodiments of this invention will be described below with reference to the drawings.

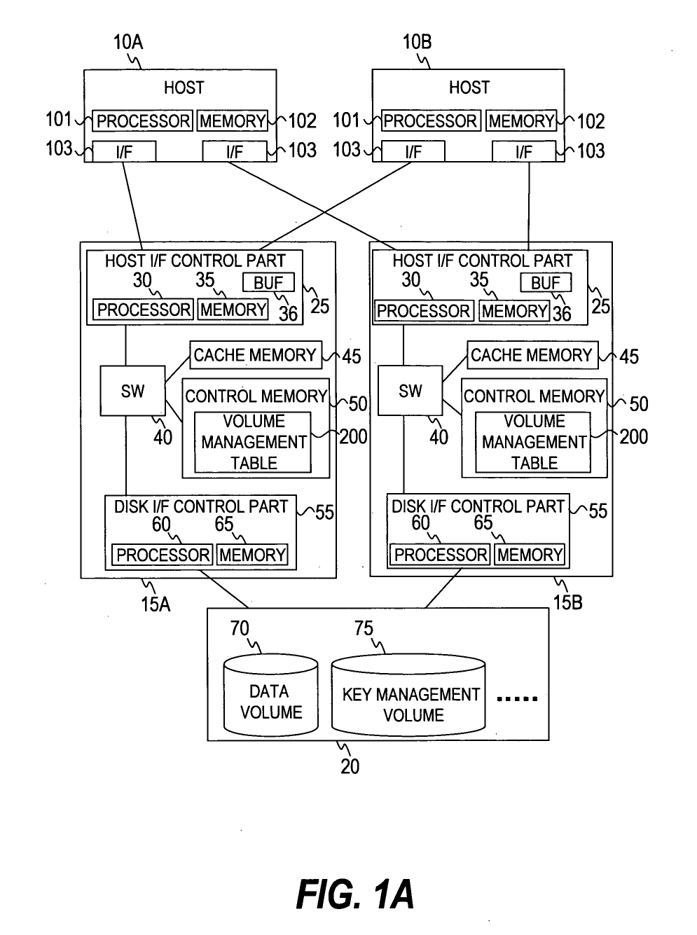

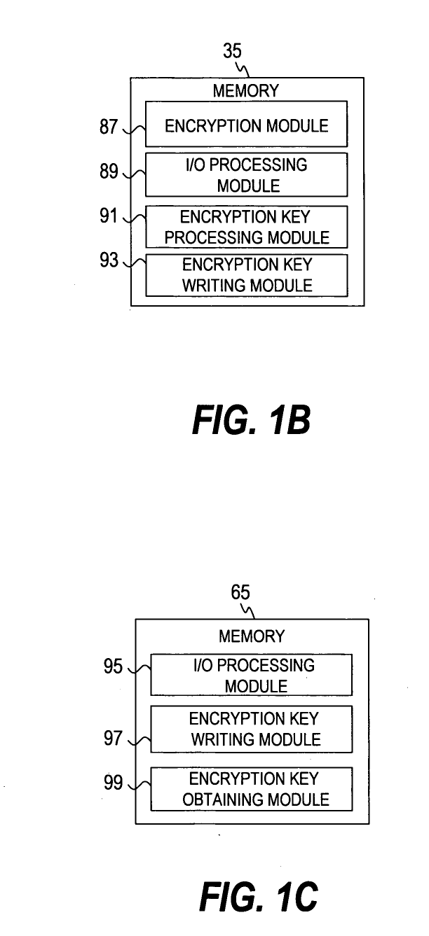

FIG. 1A is a block diagram showing a configuration of a computer system according to a first embodiment of this invention.

The computer system of FIG. 1A includes host computers 10A and 10B, storage controllers 15A and 15B, and a storage device 20. The host computers 10A and 10B are connected to the storage controllers 15A and 15B through a network (e.g. storage area network). The storage controllers 15A and 15B are connected to the storage device 20.

In the description below, when it is not necessary to distinguish the host computers 10A and 10B from each other, these will be generically referred to as a host computer 10. Similarly, when it is not necessary to distinguish the storage controllers 15A and 15B from each other, these will be generically referred to as a storage controller 15.

FIG. 1A shows the two host computers 10 and the two storage controllers 15. According to the computer system of the embodiment, however, more host computers 10 and storage controllers 15 may be installed.

For example, the host computer 10 has a function of a file server to supply data files to a user, or a database server. The host computer 10 of this embodiment includes a processor 101, a memory 102, and one or more I/F's 103 connected to one another.

The processor 101 executes a program (e.g., application program) stored in the memory 102 to realize a function of the host computer 10.

The memory 102 stores the program or the like (not shown) executed by the processor 101.

The I/F 103 is an interface connected to a network to communicate with the storage controller 15 therethrough.

The storage controller 15 supplies a data storage area of the storage device 20 to the host computer 10. In other words, the storage controller 15 reads/writes data from/in the storage device 20 according to a request issued by the host computer 10.

Each of the storage controllers 15A and 15B includes a host I/F control part 25, a cache memory 45, a control memory 50, a disk I/F control part 55, and a switch 40.

The host I/F control part 25 is an interface for connecting the storage controller 15 to the host computers 10A and 10B. For example, this interface is a fibre channel or Ethernet. However, the embodiment of this invention is not limited to this.

The cache memory 45 is a semiconductor memory for temporarily storing data transmitted between the host computer 10 and the storage device 20.

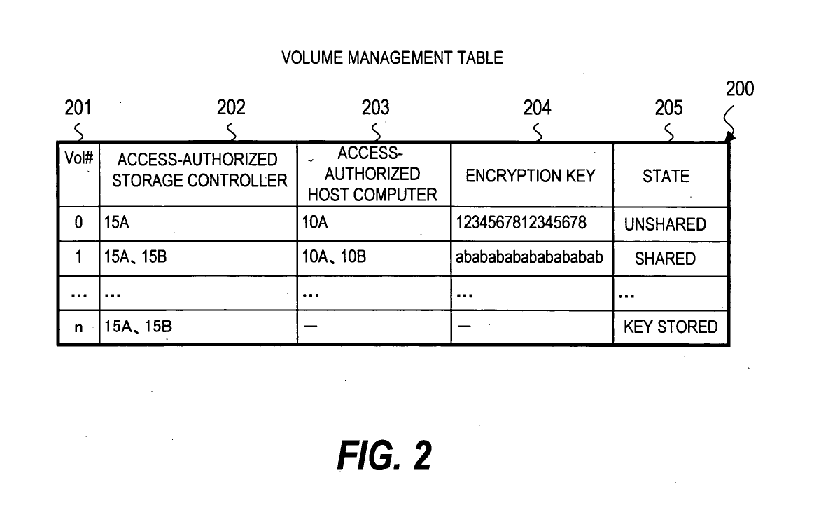

The control memory 50 is a semiconductor memory for storing and managing configuration information, control information, or the like necessary for a storage system constituted of the storage controller 15 and the storage device 20. The control memory 50 of this embodiment stores at least a volume management table 200. The volume management table 200 shown in FIG. 2 will be described below in detail.

The disk I/F control part 55 is an interface for connection with the storage device 20. For example, the interface for connection with the storage device 20 is a fiber channel or a small computer system interface (SCSI). However, the embodiment of this invention is not limited to this.

The storage device 20 includes a plurality of magnetic disks as in the case of a disk array. However, the embodiment of this invention is not limited to this. For example, the storage device 20 may include a semiconductor disk, a semiconductor memory, or a tape library. The storage device 20 does not need to be a disk array.

The storage device 20 includes a plurality of volumes. Each volume is an area generated by logically dividing a storage area of the storage device 20. The host computer 10 and an application program of the host computer recognize one volume as one disk. At least one of the volumes is a data volume 70. At least one of the rest of the volumes is an encryption key management volume 75. The data volume 70 is a storage volume which stores data written by the host computer 10. An encryption key management volume 75 is a storage volume which stores an encryption key as described below.

The switch (SW) 40 interconnects the host I/F control part 25, the cache memory 45, the control memory 50, and the disk I/F control part 55 to relay data communication among them.

The host I/F control part 25 includes a processor 30, a memory 35, and a buffer (BUF) 36.

The processor 30 executes a program stored in the memory 35.

The memory 35 stores the program or the like to be executed by the processor 30. The memory 35 shown in FIG. 1B will be described below.

The disk I/F control part 55 includes a processor 60 and a memory 65.

The processor 60 executes a program stored in the memory 65.

The memory 65 stores the program or the like to be executed by the processor 60. The memory 65 shown in FIG. 1C will be described below.

FIG. 1B is an explanatory diagram of the memory 35 installed in the host I/F control part 25 according to the first embodiment of this invention.

The memory 35 stores an encryption module 87, an I/O processing module 89, an encryption key processing module 91, and an encryption key writing module 93. These modules are programs executed by the processor 30.

The encryption module 87 executes encryption and decryption of data required to be written/read from the host computer 10. In addition, the encryption module 87 generates an encryption key necessary for encryption and decryption. Specifically, the encryption module 87 first generates an encryption key and encrypts received data by the generated encryption key when, for example, data is received from the host computer 10 (write access). Subsequently, the encryption module 87 instructs the I/O processing module 89 to store the encrypted data in the cache memory 45 or the storage device 20.

The I/O processing module 89 transfers data between the host computer and the cache memory 45 or the storage device 20 according to a request from the host computer 10.

The other modules will be described below in detail.

FIG. 1C is an explanatory diagram of the memory 65 installed in the disk I/F control part 55 according to the first embodiment of this invention.

The memory 65 stores an I/O processing module 95, an encryption key writing module 97, and an encryption key obtaining module 99. These modules are programs executed by the processor 60.

The I/O processing module 95 transfers data between the cache memory 45 and the storage device 20.

The other modules will be described below in detail.

FIG. 2 is an explanatory diagram showing an example of the volume management table 200 according to the first embodiment of this invention.

As shown in FIG. 1A, the volume management table 200 of this embodiment is stored in the control memory 50. However, the volume management table 200 may be stored anywhere as long as it can be accessed by the processors 30 and 60. For example, the volume management table 200 may be stored in the memory 35, the memory 65, or a memory in the switch 40 (not shown).

The volume management table 200 of FIG. 2 contains a volume number (Vol #), an access-authorized storage controller 202, an access-authorized host computer 203, an encryption key 204, and a state 205. These are parameters to indicate the storage controller 15 and the host computer 10 authorized to access each volume, an encryption key used for encryption processing, and a volume state.

The volume number 201 is an identifier of a volume in the storage device 20. For example, when there are n+1 volumes in the storage device 20, values of “0” to “n” shown in FIG. 2 are registered as volume numbers 201. In the description below, a volume having a volume number 201 of “0” will be referred to as “Vol #0”. The same will apply to the other volume numbers 201.

An identifier of the storage control system 15 authorized to access each volume is registered in the access-authorized storage controller 202. In the example of FIG. 2, Vol #1 and Vol #n authorize access from the storage controllers 15A and 15B. On the other hand, Vol #0 authorizes accessing only from the storage controller 15A. According to the embodiment, identifiers of the storage controllers 15A and 15B are respectively “15A” and “15B”, while identifiers of the host computers 10A and 10B are respectively “10A” and “10B”.

An identifier of the host computer 10 authorized to access each volume is registered in the access-authorized host computer 203. In the example of FIG. 2, Vol #1 authorizes accessing from the host computers 10A and 10B. On the other hand, Vol #0 authorizes accessing only from the host computer 10A.

The host computer 10 cannot access the encryption key management volume 75. Accordingly, a value of the access-authorized host computer 203 corresponding to the encryption key management volume 75 becomes blank (“−”). In the example of FIG. 2, Vol #n indicates the encryption key management volume 75.

An encryption key of data stored in each volume is registered in the encryption key 204. Only when the encryption key registered in the encryption key 204 is used, the encryption module 87 can normally decrypt the data stored in each volume.

When contents of the encryption key 204 change, the data stored in the volume cannot be normally decrypted. As a result, the decrypted data becomes a bit string totally meaningless to the host computer 10 or the application program. For example, in the example of FIG. 2, “1234567812345678” is registered as the encryption key 204 of Vol #0. In this case, when data stored in Vol #0 is decrypted by using an encryption key other than “1234567812345678”, the data is not normally decrypted, and the decrypted data becomes a meaningless bit string.

An encrypted encryption key is stored in the encryption key management volume 75 as described below. An encryption key for encrypting the encryption key is not managed based on the volume management table 200. Thus, a value of the encryption key 204 corresponding to the encryption key management volume 75 (Vol #n in the example of FIG. 2) becomes blank (“−”). In the description below, an encryption key for encrypting/decrypting the encryption key will be referred to as a key encryption key.

A value indicating a volume state is registered in the state 205. In the state 205 of this embodiment, at least one of “UNSHARED”, “SHARED”, and “KEY STORED” is registered. “UNSHARED” indicates a state where the volume is accessed from only one storage controller. “SHARED” indicates a state where the volume is accessed from a plurality of storage controllers. “KEY STORED” indicates a state where an encryption key is stored in the volume.

In the example of FIG. 2, Vol #0 is accessed only from the storage controller 15A (refer to access-authorized storage controller 202). Accordingly, “UNSHARED” is registered as the state 205 corresponding to Vol #0. Vol #1 is accessed from the storage controllers 15A and 15B. Thus, “SHARED” is registered as the state 205 corresponding to Vol #1. In the Vol #n, a value of an encryption key 204 becomes “−”. Vol #n does not store data, and is judged to be the encryption key management volume 75 which is an area for storing the encryption key. In this case, a value of the state 205 corresponding to Vol #n becomes “KEY STORED”.

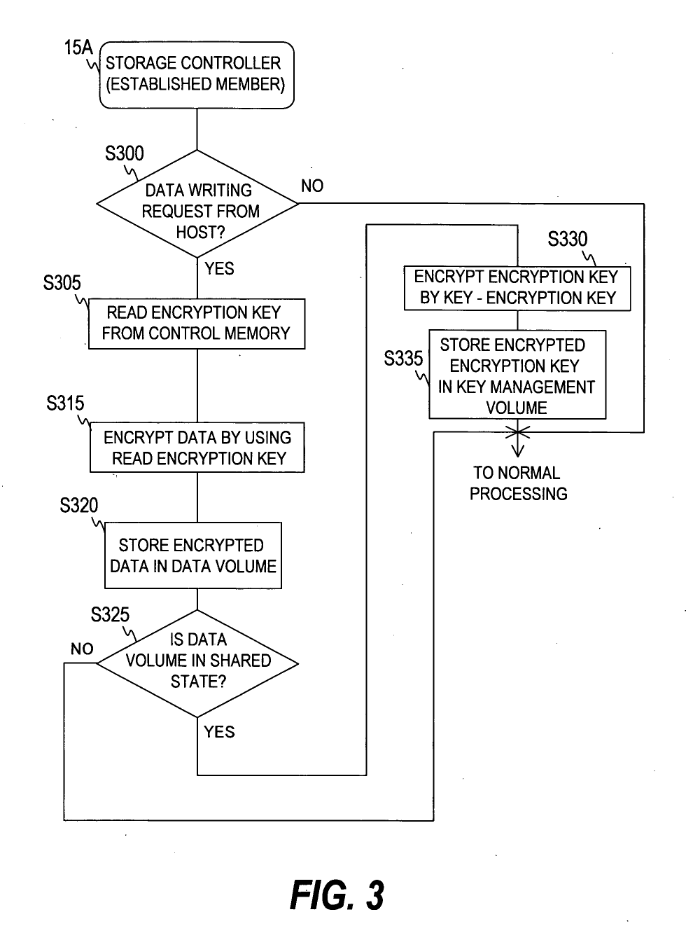

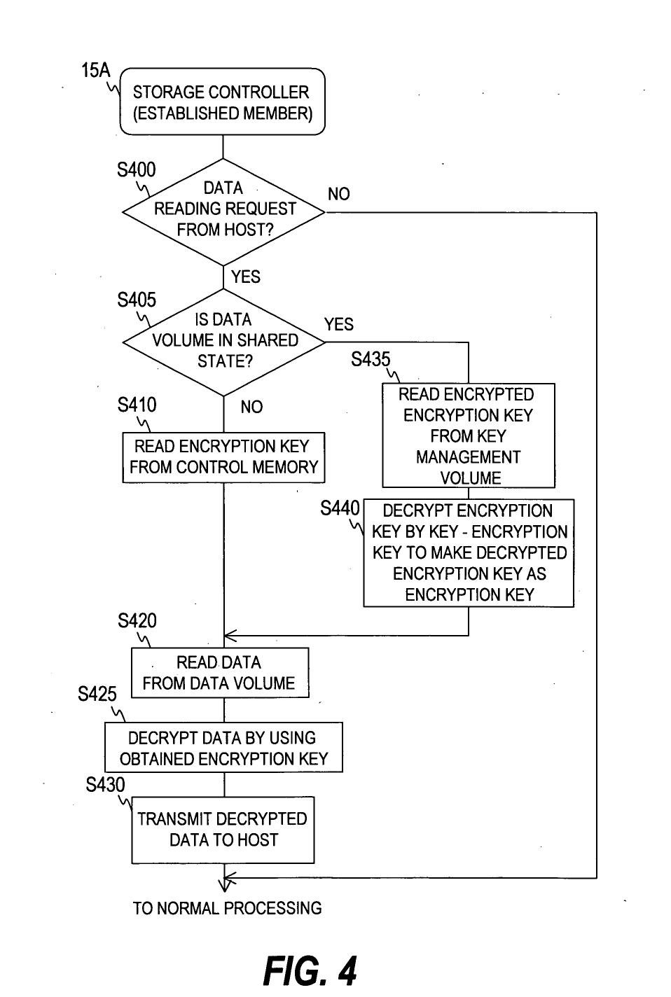

Next, referring to FIGS. 3 and 4, a process executed by the storage controller 15 which has received an accessing request from the host computer 10 will be described.

The process shown in FIGS. 3 and 4 is executed by each module of the storage controller 15 when the storage controller 15 that has already been registered as the access-authorized storage controller 202 regarding a data volume 70 receives a request of accessing the data volume 70. As a specific example, FIGS. 3 and 4 show a process when the storage controller 15A receives a request of accessing Vol #0 or Vol #1.

As described above, each module of the storage controller 15 is a program executed by the processor 30 or 60. Thus, each step of FIGS. 3 and 4 is actually executed by the processor 30 or 60.

FIG. 3 is a flowchart showing the process executed by the storage controller 15 in response to a data writing request from the host computer 10 according to the first embodiment of this invention.

In a first step S300, the I/O processing module 89 judges whether a data writing request from the host computer 10 has been received or not.

If it is judged in the step S300 that the data writing request has not been received, a normal process is executed. For example, the normal process is for waiting for a next accessing request or the like.

If it is judged in the step S300 that the data writing request has been received, the I/O processing module 89 refers to the contents of the received request to make analysis as to a volume in which wiring is to be executed, a data length, or the like, thereby securing a necessary area in the cache memory 45. Then, the encryption key processing module 91 reads an encryption key (Key 1) of a writing target volume from the volume management table 200 of the control memory 50 shown in FIG. 2 to store it in the memory 35 (S305).

In a step S315, the encryption module 87 reads the encryption key “Key 1” stored in the memory 35 in the step S305, and encrypts data received from the host computer by using the encryption key “Key 1”. Upon completion of the encryption, the encryption module 87 notifies the completion to the I/O processing module 89.

The I/O processing module 89 receives the notification, then stores the encrypted data in the area of the cache memory 45 secured in the step S300. Lastly, the I/O processing module 95 reads the data stored in the cache memory 45, and stores the data in the target data volume 70 of the data writing request (S320).

In a step S325, the encryption key processing module 91 judges whether the target data volume 70 of the data writing request is in a shared state or not. Specifically, the encryption key processing module 91 judges whether the state 205 of the volume management table 200 of the control memory 50 is “SHARED” or not. If the target data volume 70 of the data writing request is Vol #0, an unshared state is judged. If the data volume 70 is Vol #1, a shared state is judged.

If it is judged in the step S325 that the target data volume 70 of the data writing request is in an unshared state, the data volume 70 is not accessed from the other storage controller 15. In this case, the process returns to a normal operation.

On the other hand, if it is judged in the step S325 that the target data volume 70 of the data writing request is in a shared state, the data volume 70 is accessed from the other storage controller 15. In this case, the following steps are executed as the encryption key “Key 1” used for the data encryption in the step S315 must be shared with the other storage controller.

First, in a step S330, the encryption key processing module 91 encrypts the key encryption key “Key 1” by a key encryption key “Key K” to generate an encryption key “Key 2”. According to this embodiment, the key encryption key “Key K” is generated in the storage controller.

Next, in a step S335, the encryption key writing module 93 refers to the volume management table 200 in the control memory 50 to store the encryption key “Key 2” in the encryption key management volume 75 (Vol #n in the example of FIG. 2). Subsequently, a normal process is executed.

FIG. 4 is a flowchart showing the process executed by the storage controller 15 in response to a data reading request from the host computer 10 according to the first embodiment of this invention.

Detailed description of portions of FIG. 4 similar to those of FIG. 3 will be omitted.

In a first step S400, the I/O processing module 89 judges whether the data reading request from the host computer 10 has been received or not.

If it is judged in the step S400 that the data reading request has not been received, a normal process is executed.

If it is judged in the step S400 that the data reading request has been received, the I/O-processing module 89 refers to the contents of the received request to judge a volume from which reading is to be executed, a data length, presence of requested data in the cache memory 45, or the like.

Next, the encryption key processing module 91 judges whether the target data volume 70 of the data reading request is in a shared state or not (S405). Specifically, as in the step S325 of FIG. 3, the encryption key processing module 91 refers to the volume management table 200 of the control memory 50. As a result, the process proceeds to a step S435 if the data volume 70 is judged to be in the shared state. The process proceeds to a step S410 if the data volume 70 is judged to in an unshared state.

If the target data volume 70 of the data reading request is in the unshared state, it is not necessary to share an encryption key as the data volume 70 is not accessed from the other storage controller 15. Accordingly, the encryption key of the data volume 70 is managed in the storage controller 15 which accesses the data volume 70. Hence, in the step 410, the encryption key processing module 91 reads the encryption key of the data volume 70 from the volume management table 200 of the control memory 50 to store it in the memory 35.

On the other hand, if the target data volume 70 of the data reading request is in the shared state, the data volume 70 is also accessed from the other storage controller. Thus, a plurality of storage controllers 15 must share the encryption key. In this case, there is a possibility that decryption will not be correctly executed by the encryption key of the data volume 70 managed by the storage controller 15 which has received the data reading request. Hence, the encryption key obtaining module 99 refers to the volume management table 200 in the control memory 50 to read an encrypted encryption key (Key 2 in the example of FIG. 3) from the encryption key management volume 75 (Vol #n in the example of FIG. 2) (S435). Then, the encryption key obtaining module 99 temporarily stores the read encryption key “Key 2” as the encryption key 204 of the target data volume 70 of the data reading request in the control memory 50.

The encryption key processing module 91 reads the encryption key “Key 2” registered in the step S435, decrypts the encryption key “Key 2” to be an original encryption key “Key 1” by using a key encryption key, and stores the encryption key “Key 1” in the control memory 50 again (S440). Specifically, the Key 1 is registered as the encryption key 204 corresponding to the target data volume 70 of the data reading request in the volume management table 200.

According to the embodiment, the encryption key (Key 2) read from the encryption key management volume 75 and the encryption key (Key 1) obtained by using the key encryption key to decrypt the encryption key are registered in the volume management table 200. However, these encryption keys do not need to be registered in the volume management table 200. For example, after the data of the data volume 70 is decrypted by using the Key 1, the Key 1 and the Key 2 may be deleted from the control memory 50. In this case, each time an encryption key becomes necessary, the encryption key is read from the key management table 75, and is decrypted by using the key encryption key.

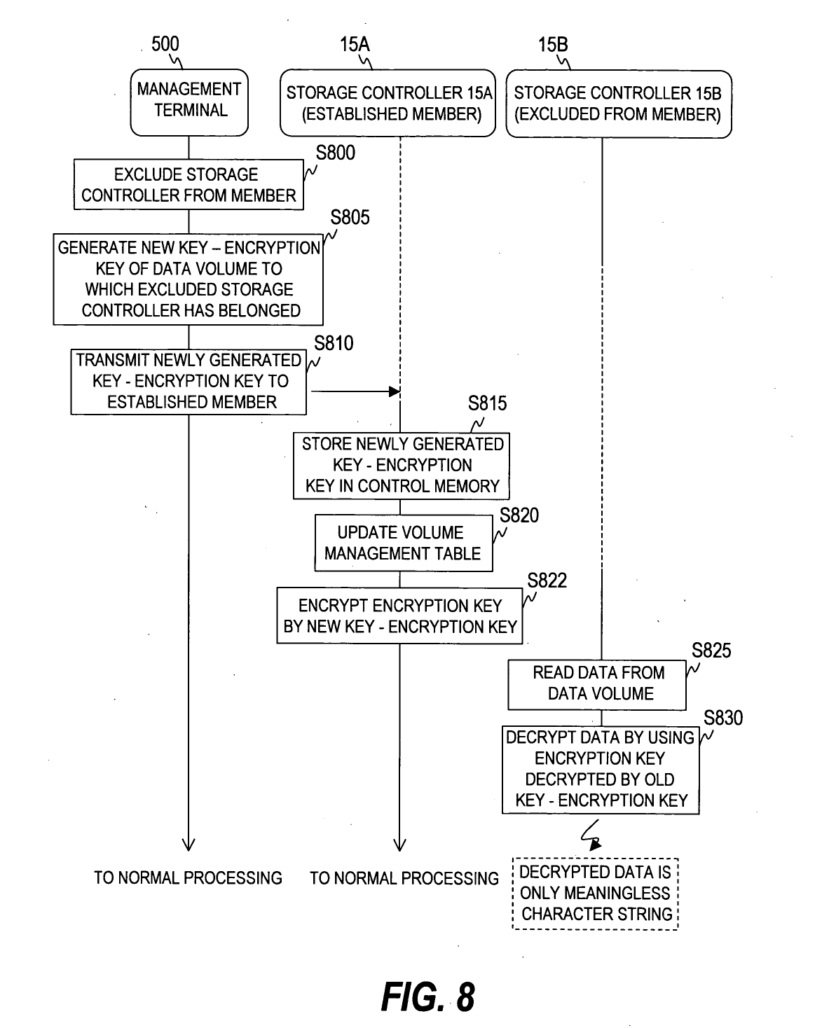

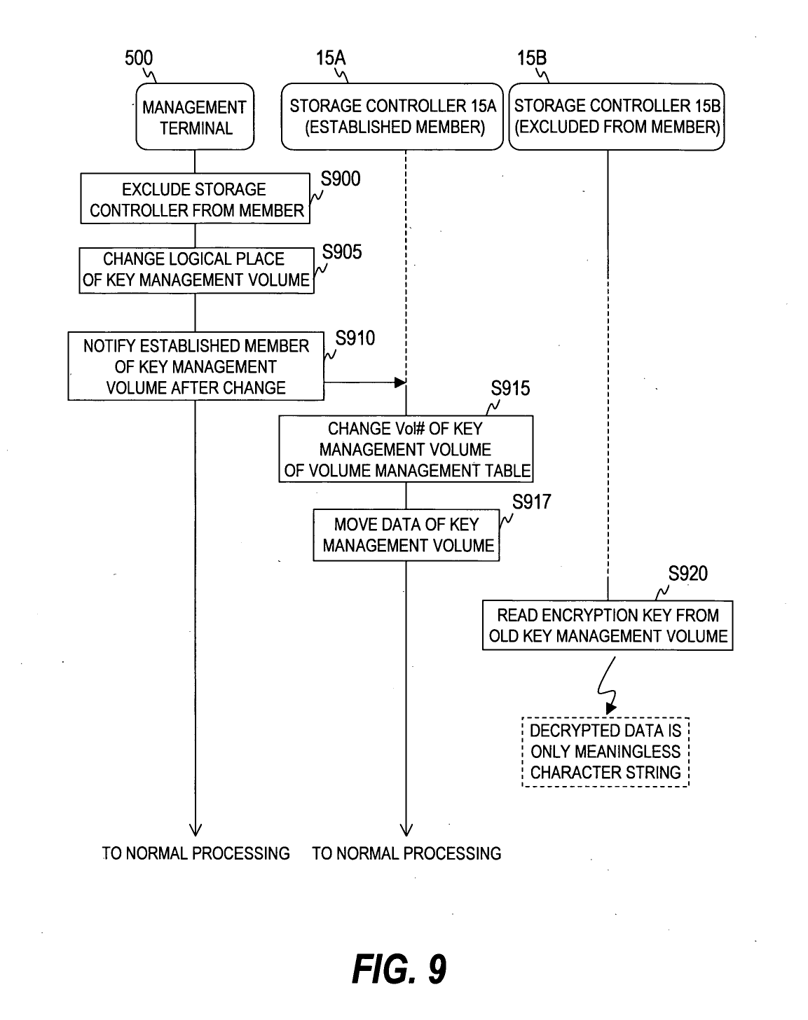

Thus, data leakage may be prevented by leaving no encryption key in the storage controller 15 shown in detail in FIGS. 8 and 9.

After the execution of the step S410 or S440, the I/O processing module 95 next reads target data of the data reading request from the target data volume 70 in the storage device 20 (S420). When the requested data is present in the cache memory 45, the I/O processing module 95 reads the data from the cache memory 45.

Next, the encryption module 87 decrypts the read data by using the encryption key obtained in the step S410 or S440 (S425).

Then, the I/O processing module 89 transmits the decrypted data to the host computer 10 (S430). Subsequently, a normal process is executed.

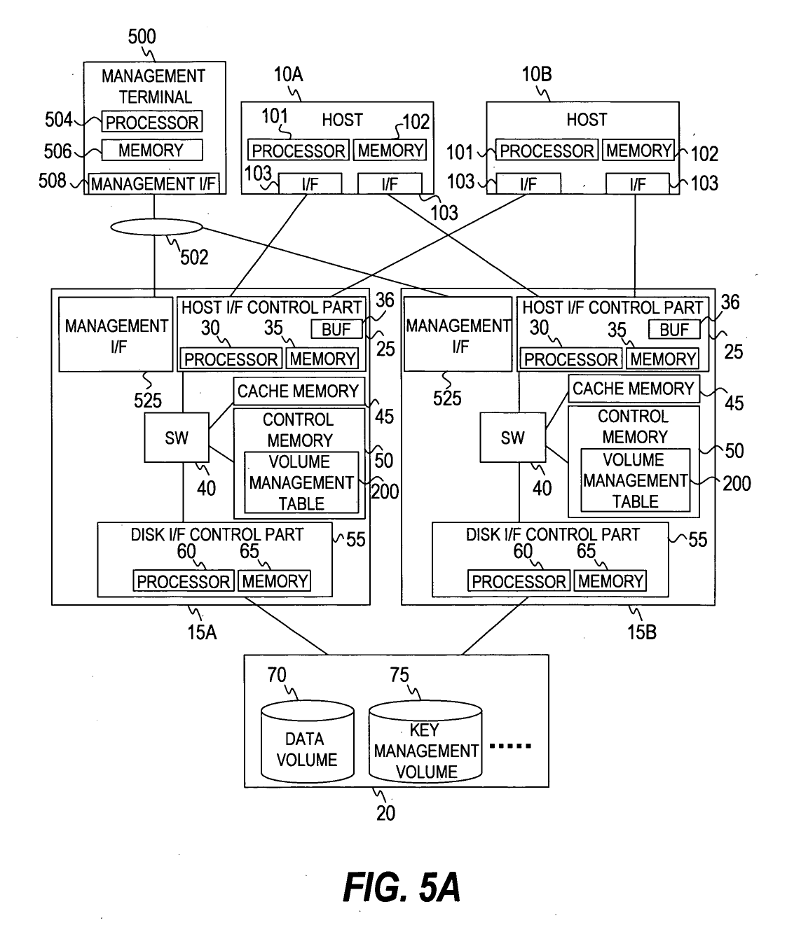

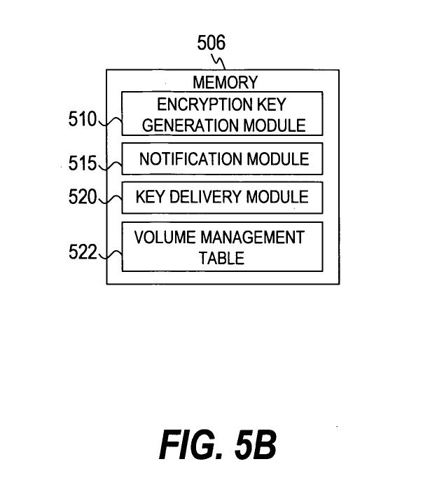

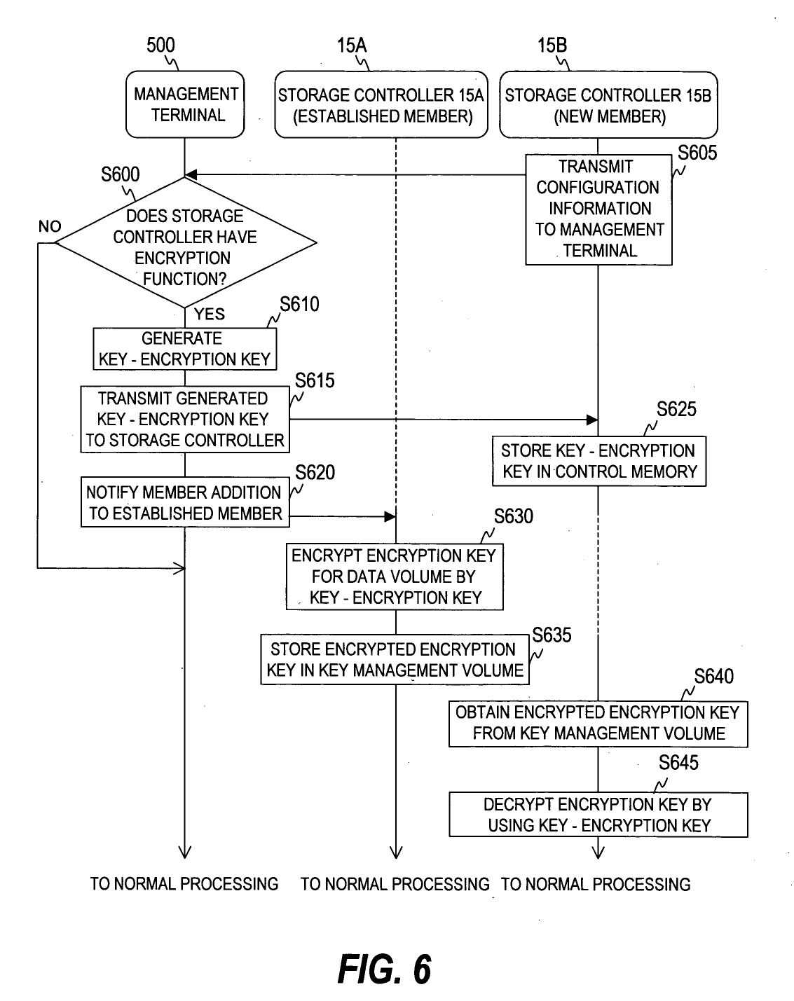

Next, referring to FIGS. 5A, 5B, and 6, a second embodiment of this invention will be described.

FIG. 5A is a block diagram showing a configuration of a computer system according to the second embodiment of this invention.

The computer system shown in FIG. 5A is different from that of FIG. 1A in that a management terminal 500 is connected to a storage controller 15 through a network 502, and the storage controller 15 includes a management I/F 525 equipped with an interface for communication with the management terminal 500. Differences between FIG. 5A and FIG. 1A will be described hereinafter. Description of common points between FIG. 5A and FIG. 1A will be omitted.

The management terminal 500 is a computer for changing a configuration of a storage device, monitoring a state, and collecting fault information. The management terminal 500 of the embodiment includes a processor 504, a memory 506, and a management I/F 508 connected to one another.

The processor 504 executes a program stored in the memory 506 to realize a function of the management terminal 500.

The memory 506 stores the program or the like executed by the processor 504. The memory 506 shown in FIG. 5B will be described below.

The management I/F 508 is an interface connected to the network 502 to communicate with the storage controller 15 therethrough.

On the other hand, the management I/F 525 of the storage controller 15 is an interface connected to the network 502 to communicate with the management terminal 500 therethrough.

FIG. 5B is an explanatory diagram of the memory 506 installed in the management terminal 500 according to the second embodiment of this invention.

An encryption key generation module 510, a notification module 515, a key delivery module 520, and a volume management table 522 are stored in the memory 506. The encryption key generation module 510, the notification module 515, and the key delivery module 520 are programs executed by the processor 504.

The encryption key generation module 510 generates a key encryption key used when an encryption key writing module 93 of the storage controller 15 stores an encryption key in an encryption key management volume 75 of a storage device 20.

The key delivery module 520 delivers the encryption key generated by the encryption key generation module 510 to the storage controller 15.

When the key encryption key is delivered to the storage controller 15, simple delivery is not preferable from the standpoint of security. It is because of a possibility that data will leak from a storage controller 15 if the key encryption key is delivered to the storage controller 15 which needs no delivery. Accordingly, the volume management table 522 is stored in the memory 506 of the management terminal 500. The contents of the volume management table 522 are similar to those of the volume management table. 200. The key delivery module 520 refers to the volume management table 522 to deliver the key encryption key to a proper storage controller 15.

Specifically, the key delivery module 520 delivers (transmits) the key encryption key to the storage controller 15 registered as an access-authorized storage controller 202. For example, when the contents of the volume management table 522 are similar to those of the volume management table 200 of FIG. 2, the key delivery module 520 delivers a key encryption key used for Vol #0 to a storage controller 15A, and a key encryption key used for Vol #1 to storage controllers 15A and 15B.

FIG. 6 is an explanatory diagram of a process where the management terminal 500 delivers the key encryption key according to the second embodiment of this invention.

Referring to FIG. 6, description will be made by taking an example of Vol #0 of the volume management table 200 shown in FIG. 2. In FIG. 2, only the storage controller 15A is authorized to access the Vol #0. Thus, the state 205 of the Vol #0 is “UNSHARED”. Now, description will be made of a case where the storage controller 15B is newly authorized to access the Vol #0, and the state 205 of the Vol #0 becomes “SHARED”. In FIG. 6, the storage controller that has obtained access authorization is set as “ESTABLISHED MEMBER”, and the storage controller 15B that newly obtains access authorization is set as “NEW MEMBER”.

In the description below, the process (including a process executed by each module of the management terminal 500) executed by the management terminal 500 is actually executed by the processor 504. The process (including a process executed by each module of the storage controller 15) executed by the storage controller 15 is actually executed by a processor 30 or 60.

First, an I/O processing module 89 of the storage controller 15B as a new member transmits configuration information of the storage controller 15B to the management terminal 500 (S605). The configuration information transmitted at this time contains information that the storage controller 15B includes a data encryption function.

The management terminal 500 judges whether the storage controller 15B as the new member includes a data encryption function or not (S600). For this judgment, the management terminal 500 refers to the configuration information transmitted in the step S605.

If it is judged in the step S600 that the storage controller 15B does not include a data encryption function, nothing is executed to return to a normal process.

On the other hand, if it is judged in the step S600 that the storage controller 15B includes a data encryption function, an encryption key generation module 510 generates a key encryption key (S610).

Next, a key delivery module 520 delivers the key encryption key generated by the encryption key generation module 510 to the storage controller 15B (S615). In this case, the key delivery module 520 updates the volume management table 522 of the management terminal 500.

The management I/F 525 of the storage controller 15B receives the key encryption key from the management terminal 500. An encryption key writing module 93 stores the received key encryption key in the control memory 50 (S625).

The notification module 515 notifies the addition of the storage controller 15B which accesses the Vol #0 and the generation of the key encryption key to the storage controller 15A (S620). In this case, the key delivery module 520 also transmits the generated key encryption key to the storage controller 15A.

Upon reception of the notification of the step S620, an encryption key processing module 91 encrypts an encryption key used for data of the Vol #0 by using the received key encryption key (S630).

Next, the encryption key writing module 93 stores the encrypted encryption key in an encryption key management volume 75 based on the volume management table 200 (S635).

Subsequently, the storage controller 15 that has received a data writing or reading request from a host computer 10 executes the process shown in FIG. 3 or 4. For example, the storage controller 15B that has received the data reading request obtains the encrypted encryption key from the encryption key management volume 75 (S640), and the encryption key is decrypted by using a key encryption key (S645). The steps S640 and S645 correspond to the steps S435 and S440 of FIG. 4.

Thus, the storage of the encryption key of the data volume 70 in the encryption key management volume 75 enables sharing of the encryption key among the plurality of storage controllers 15. The encryption key stored in the encryption key management volume 75 is encrypted by the key encryption key, and the key encryption key is delivered only to the storage controller 15 authorized to access the data volume 70. Hence, it is possible to prevent data leakage caused by illegal use of the encryption key.

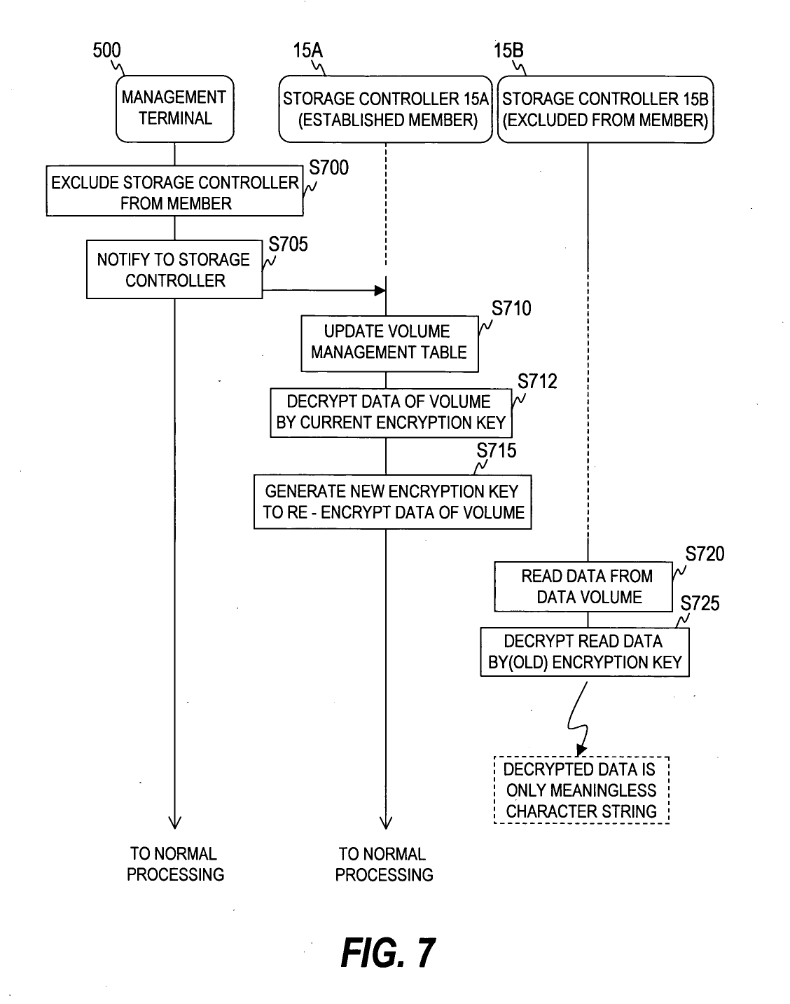

Next, description will be made of a process executed when the storage controller 15 is prohibited from accessing the data volume 70. Even when the storage controller 15 that has been authorized to access the data volume 70 is prohibited from accessing the data volume 70 at a certain point of time, as long as an encryption key itself of the data volume 70 is left in the storage controller 15, there is a possibility that the encryption key will be used to decrypt data of the data volume 70, thereby causing illegal leakage of the data to the outside. Alternatively, even when the encryption key of the data volume 70 is not left, as long as a key encryption key used for the encryption key is left, there is a possibility that the encryption key will be read from the encryption key management volume 75 to cause leakage of the data as in the above case. Referring to FIGS. 7 to 10, a method of preventing such data leakage will be described.

FIG. 7 is an explanatory diagram of a process executed when the storage controller 15 is prohibited from accessing the data volume 70 according to the second embodiment of this invention.

According to the process of FIG. 7, when one of the storage controllers 15 is prohibited from accessing the data volume 70, to prevent illegal data leakage from the access-prohibited storage controller 15, the data is encrypted again by a different encryption key. A configuration of the storage controller 15 or the like is as shown in FIG. 5A or the like.

FIG. 7 shows a case where the storage controller 15B is excluded from an access-authorized storage controller 202 (in other words, case where the storage controller 15B is prohibited from accessing the Vol #1 which has been authorized) by taking an example of the Vol #1 of the volume management table 200. In the example below, at the time of starting the process of FIG. 7, the contents similar to those of the volume management table 200 have been registered in the volume management table 522.

First, the management terminal 500 excludes “15B” from the access-authorized storage controller 202 corresponding to the Vol #1 in the volume management table 522 (S700), and the notification module 515 notifies the exclusion to the storage controller 15A (S705). When there is a storage controller 15 authorized to access the Vol #1 in addition to the storage controller 15A, the exclusion is also notified to the storage controller 15.

As in the step S700, the storage controller 15A updates the volume management table 200. Specifically, the storage controller 15A excludes “15B” from the access-authorized storage controller 202 corresponding to the Vol #1 in the volume management table 200 (S710).

Incidentally, an encryption key 204 corresponding to the Vol #1 is left in the volume management table 200 of the storage controller 15B, thereby making a possibility that this encryption key will be illegally used to cause illegal data leakage to the outside. In the process of FIG. 7, therefore, a new encryption key is generated for data of the Vol #1, and the data of the Vol #1 is encrypted again by the new encryption key. Thus, even when the data of the Vol #1 is decrypted by using the encryption key left in the storage controller 15B, the normal decryption becomes impossible. In other words, it is possible to eliminate the possibility that the encryption key left in the storage controller 15B will cause the illegal data leakage to the outside.

Specifically, the I/O processing module 89 of the storage controller 15A reads the data of the Vol #1 from the storage device 20 (or cache memory 40), and the encryption module 87 decrypts the data by a current encryption key (S712).

Next, the encryption module 87 generates a new encryption key, and encrypts the data of the Vol #1 by using the new encryption key. The I/O processing module 95 stores the encrypted data in the Vol #1 (S715).

Subsequently, even when the excluded storage controller 15B reads the data of the Vol #1 (S720), the data is decrypted by an old encryption key of the storage controller 15B (S725), the decrypted data turns into a meaningless character string. In other words, the storage controller 15B cannot correctly decrypt the data of the Vol #1.

Thus, the execution of the process shown in FIG. 7 prevents the data leakage caused by the encryption key left in the access-prohibited storage controller 15. According to the process of FIG. 7, however, after all the data stored in the data volume 70 are decrypted, the data must be encrypted again by a new encryption key. As a result, it is expected that a great deal of processing time will be expended and many hardware resources will be consumed. Referring to FIGS. 8 and 9, a simpler method of preventing data leakage will be described below. Processes of FIGS. 8 and 9 are based on the premise that the encryption key is not registered in the volume management table 200 in the step S440 of FIG. 4.

FIG. 8 is an explanatory diagram of another process executed when the storage controller 15 is prohibited from accessing the data volume 70 according to the second embodiment of this invention.

Different from the process of FIG. 7, according to the process shown in FIG. 8, when the storage controller 15 is prohibited from accessing the data volume 70, to prevent illegal data leakage from the storage controller 15, the encryption key generation module 510 of the management terminal 500 regenerates a key encryption key, thereby changing the key encryption key. A configuration of the storage controller 15 or the like is as shown in FIG. 5A or the like.

Referring to FIG. 8, as in the case of FIG. 7, description will be made of a case where the storage controller 15B is excluded from the access-authorized storage controller 202 by taking an example of the Vol #1 of the volume management table 200.

First, the management terminal 500 excludes “15B” from the access-authorized storage controller 202 corresponding to the Vol #1 in the volume management table 522 (S800).

Next, the encryption key generation module 510 generates a new key encryption key of the Vol #1 (S805).

Then, the key delivery module 520 transmits the newly generated key encryption key to the storage controller 15A (S810). When there is a storage controller 15 authorized to access the Vol #1 in addition to the storage controller 15A, the newly generated key encryption key is also transmitted to the storage controller 15.

The storage controller 15A stores the key encryption key transmitted from the management terminal 500 in the control memory 50 (S815). In the description of FIG. 8 below, the key encryption key transmitted from the management terminal 500 will be referred to as a new key encryption key, and the key encryption key used before the transmission of the new key encryption key will be referred to as an old key encryption key.

Next, as in the step S800, the storage controller 15A updates the volume management table 200. Specifically, the storage controller 15A excludes “15B” from the access-authorized storage controller 202 corresponding to the Vol #1 in the volume management table 200 (S820).

Next, the encryption key processing module 91 decrypts the encryption key to be used for the Vol #1 by using an old key encryption key, and encrypts the encryption key by using a new key encryption key (S822). Further, in the step S822, the encryption key writing module 93 stores the encrypted encryption key in the encryption key management volume 75 based on the volume management table 200. When the volume management table 200 is as shown in FIG. 2, the Vol #n is the encryption key management volume 75. Accordingly, the encryption key writing module 93 stores the encrypted encryption key in the Vol #n.

Subsequently, the excluded storage controller 15B can read data from the Vol #1 (S825), and further can read the encryption key to be used for the Vol #1 from the Vol #n. However, the storage controller 15B does not have a new encryption key for the Vol #1 and therefore cannot correctly decrypt the read encryption key. In other words, when the storage controller 15B decrypts the encryption key read from the Vol #n by the old key encryption key (S830), and decrypts the data of the Vol #1 by using the decrypted encryption key, the decrypted data turns into a meaningless character string. Hence, the storage controller 15B cannot correctly decrypt the data of the Vol #1.

In the manner as described above, the key encryption key is changed to thereby enable prevention of data leakage owing to encryption key that remains in the excluded storage controller 15, without encrypting the data of the data volume 70 by the new encryption key.

FIG. 9 is an explanatory diagram of another process executed when the storage controller 15 is prohibited from accessing the data volume 70 according to the second embodiment of this invention.

Different from the processes of FIGS. 7 and 8, according to the process shown in FIG. 9, when the storage controller 15 is prohibited from accessing the data volume 70, the encryption key stored in the encryption key management volume 75 is moved to a different encryption key management volume 75 to prevent illegal data leakage from the storage controller 15. A configuration of the storage controller 15 or the like is as shown in FIG. 5A or the like.

Referring to FIG. 9, as in FIGS. 7 and 8, description will be made of a case where the storage controller 15B is excluded from the access-authorized storage controller 202 by taking an example of the Vol #1 in the volume management table 200.

First, the management terminal 500 excludes “15B” from the access-authorized storage controller 202 corresponding to the Vol #1 in the volume management table 522 (S900).

Next, the management terminal 500 changes a logical place of the encryption key management volume 75 (S905). Specifically, when the storage device 20 includes a plurality of encryption key management volumes 75, the management terminal 500 may decide to move the encryption key to another encryption key management volume 75. When the movement is executed according to this decision, the encryption key is newly stored in an encryption key management volume 75 of a movement destination, and deleted from an encryption key management volume 75 of a movement source.

In the description below, the encryption key management volume 75 of the movement destination (i.e., encryption key management volume 75 after the change) will be referred to as “new encryption key management volume 75”, and the encryption key management volume 75 of the movement source (i.e., encryption key management volume 75 before the change) will be referred to as “old encryption key management volume 75”.

Next, the notification module 515 transmits a notification of a volume number 201 of the new encryption key management volume 75 to the storage controller 15A (S910). For example, when the encryption key moves from the Vol #n to Vol #m, “m” is transmitted.

When there is a storage controller 15 authorized to access the Vol #1 in addition to the storage controller 15A, the notification is also transmitted to this storage controller 15.

As in the step S900, the storage controller 15A updates the volume management table 200 (S915). Specifically, the storage controller 15A excludes “15B” from the access-authorized storage controller 202 corresponding to the Vol #1 in the volume management table 200.

For example, when the encryption key used by the storage controller 15A moves from the Vol #n to the Vol #m (not shown), “15A” is deleted from the access-authorized storage controller 202 corresponding to the Vol #n in the volume management table of the storage controller 15A. In this case, m is a natural number other than n. “15A” is registered in the access-authorized storage controller 202 corresponding to the Vol #m, and “KEY STORED” is registered in a state 205 corresponding to the Vol #m.

Then, the change of the step S915 is accompanied by movement of the encryption key stored in the old encryption key management volume 75 (Vol #n in the above example) to the new encryption key management volume 75 (Vol #m in the example) which is carried out by the storage controller 15A (S917). Specifically, the storage controller 15A deletes the encryption key corresponding to the Vol #1 from the old encryption key management volume 75 to newly store the encryption key in the new encryption key management volume 75.

Still thereafter, the excluded storage controller 15B can access the old encryption key management volume 75 (S920). However, as the encryption key of the Vol #1 has been deleted from the old encryption key management volume 75, the storage controller 15B cannot obtain the encryption key of the Vol #1. Without having been notified of the volume number 201 of the new encryption key management volume, the storage controller 15B cannot obtain the encryption key by accessing the new management volume 75. This means that the storage controller 15B cannot correctly decrypt the data of the Vol #1.

In the manner as described above, the movement of the encryption key to another encryption key management volume 75 enables prevention of data leakage owing to the excluded storage controller 15 without encrypting the data of the data volume 70 by the new encryption key.

According to the process of FIG. 9, the encryption key corresponding to the Vol #1 moves from the Vol #n to the Vol #m. On the other hand, the encryption key corresponding to the Vol #0 is continuously stored in the Vol #n without being moved. Thus, according to the process of FIG. 9, encryption keys used for different data volumes 70 (e.g., Vol #0 and Vol #1) may be stored in different encryption key management volumes 75 (e.g., Vol #n and Vol “m”).

In FIG. 9, the encryption key stored in the encryption key management volume 75 moves to another encryption key management volume 75. However, the data stored in the data volume 70 may move to another data volume 70. Description will now be made of a case where the storage controller 15B is excluded from the access-authorized storage controller 202 by taking an example of the Vol #1 of the volume management table 200 in the data moving process.

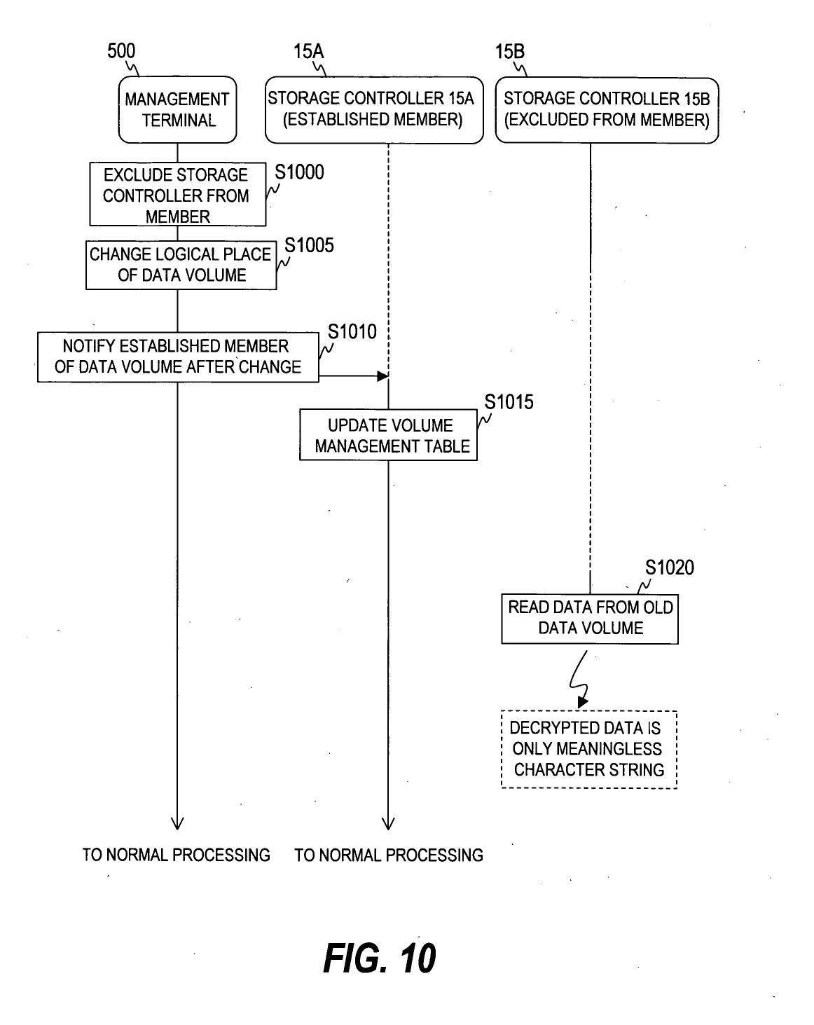

FIG. 10 is an explanatory diagram of another process executed when the storage controller 15 is prohibited from accessing the data volume 70 according to the second embodiment of this invention.

First, the management terminal 500 excludes “15B” from the access-authorized storage controller 202 corresponding to the Vol #1 in the volume management table 522 (S1000).

Next, the management terminal 500 changes a logical place of the data volume 70 (S1005). Specifically, for example, the management terminal 500 instructs the storage device 20 to create Vol #2 (not shown) as a new data volume 70, and to move the data stored in the Vol #1 to the Vol #2. As a result of changing the logical place of the data volume 70, the data stored in the Vol #1 before the change is stored in the Vol #2 after the change, and the Vol #1 after the change becomes blank. Another new data may be stored in the blank Vol #1. However, this data is encrypted by an encryption key different from that of the data before the change.

Next, the notification module 515 transmits a notification regarding the logical place of the data volume 70 after the change to the storage controller 15A (S1010). In the above example, a value “2” of a volume number 201 of the Vol #2 after the change is transmitted.

Upon reception of the notification, the storage controller 15A updates the volume management table 200 (S1015). Specifically, in the volume management table 200, the storage controller 15A updates values of the access-authorized storage controller 202, the access-authorized host computer 203, the encryption key 204 and the state 205 registered corresponding to the value “1” of the volume number 201 to register them corresponding to a value “2” of the volume number 201.

In the example of FIG. 2, “15A”, “10A, 10B”, “ababababababababab”, and “UNSHARED” are respectively registered as the access-authorized storage controller 202, the access-authorized host computer 203, the encryption key 204, and the state 205 corresponding to the value “2” of the volume number 201 (not shown). In addition, the storage controller 15A deletes the encryption key corresponding to the Vol #1 from the encryption key management volume 75. Specifically, the encryption key writing module 93 deletes the encryption key of the Vol #1. In this case, the value may be cleared to 0, or a totally unrelated value may be written.

Further, the storage controller 15A deletes the encryption key registered for the data volume 70 before the change from the volume management table 200. In the example of FIG. 2, the value “ababababababababab” of the encryption key 204 corresponding to the value “1” of the volume number 201 is deleted.

Subsequently, upon reception of a reading request of the data volume 70 from the host 10A or the like, the storage controller 15A reads data from the data volume 70 (e.g., Vol #2) after the change, and decrypts the data by using the encryption key (e.g., “ababababababababab”) registered in the volume management table 200. As a result, the storage controller 15A obtains normal data.

On the other hand, the storage controller 15B is not notified of the movement of the data. Accordingly, upon reception of the reading request of the data volume 70 from the host 10 or the like, the storage controller 15B reads the data from the data volume 70 before the change (e.g., Vol #1) (S1020). However, as the data read from the Vol #1 does not correspond to the encryption key before the change (e.g., “ababababababababab”), the decrypted data of the Vol #1 becomes meaningless.

The volume management table 200 of the storage controller 15B is not updated. In other words, in the volume management table 200 of the storage controller 15B, an encryption key (e.g., “ababababababababab”) necessary for decrypting the data of the data volume 70 after the change (e.g., Vol #2) has not been registered. Thus, even when the storage controller 15B receives a reading request which targets the Vol #2, the storage controller 15B cannot correctly decrypt the data of the Vol #2.

Thus, data leakage is prevented by the encryption key left in the excluded storage controller 15.

This invention is not limited to the above-described embodiments. For example, it can be applied as follows.

According to above-described embodiments, the encryption process of the data and the encryption key is executed by the host I/F control part 25. However, other portions of the storage controller 15 may be encrypted as long as they are lastly encrypted in the storage unit 20. For example, when the disk I/F control part 55 executes an encryption process, the above-described embodiments can be realized as long as the encryption module 87 and the encryption key processing module 91 of the memory 35 are stored in the memory 65. When the SW 40 executes an encryption process, the above-described embodiments can be realized as long as the SW 40 includes a processor (not shown) and a memory (not shown), and the encryption module 87 and the encryption key processing module 91 are stored in the memory.

According to each embodiment, the encryption key may be generated based on the contents of the data writing or reading request issued from the host computer.

According to each embodiment, the storage controller 15 and the storage device 20 may be connected to each other through a network.

According to each embodiment, a part of the functions realized by the program may be realized by hardware. Conversely, a part of the functions realized by the hardware may be realized by software.

According to each embodiment, keys for encrypting (encryption keys) and keys for decrypting (decryption keys) the data may be different. For example, a so-called public key may be used an encryption key, and a so-called secret key may be used as a decryption key. In this case, for example, “decryption key (not shown)” is registered in addition to “encryption key 204” in the volume management table shown in FIG. 2, and each is managed, whereby the embodiment can be realized.

According to each embodiment, the same encryption module may execute a data encryption process and a key encryption process.

According to the first and second embodiments, the storage of the encryption key used for decrypting the data of the data volume 70 in the encryption key management volume 75 enables sharing of the encryption key among the plurality of storage controllers 15. As a result, in an environment where the plurality of storage controllers 15 are authorized to access one data volume 70, even when the storage controller which has written data and the storage controller which has read the data are different from each other, the data can be correctly decrypted. The encryption key stored in the encryption key management volume 75 is encrypted by the key encryption key, and the key encryption key is delivered only to the storage controller 15 authorized to access the data volume 70. Hence, it is possible to prevent data leakage caused by illegal use of the encryption key stored in the encryption key management volume 75.

When the storage controller 15 is prohibited from accessing the data volume 70, the data of the data volume 70 is encrypted by a new encryption key. As a result, it is possible to prevent data leakage caused by an encryption key left in the access-prohibited storage controller 15.

Alternatively, when the storage controller 15 is prohibited from accessing the data volume 70, the key encryption key is changed, or the storing location thereof is changed. As a result, it is possible to prevent data leakage.

What is claimed is:

1. A computer system, comprising:
one or more host computers; and
a plurality of storage controllers coupled to the host computer through a first network,
wherein the host computer comprises:
a first interface coupled to the first network;
a first processor coupled to the first interface; and
a first memory coupled to the first processor,
each of the storage controllers, comprises:
one or more second processors; and
one or more second memories coupled to the second processors, the storage controllers each being coupled to a storage device for storing data, and
the second processor
encrypts data by using a first encryption key upon reception of a writing request of the data from the host computer,
stores the encrypted data and the first encryption key in the storage device,
reads the encrypted data and the first encryption key from the storage device upon reception of a reading request of the data from the host computer, and
decrypts the encrypted data by using the read first encryption key.

2. The computer system according to claim 1,
wherein the second processor
encrypts the first encryption key by using a second encryption key,
stores the encrypted first encryption key in the storage device,
decrypts the first encryption key read from the storage device by using the second encryption key, and
decrypts the encrypted data by using the decrypted first encryption key.

3. The computer system according to claim 1,
wherein the storage device includes:
a plurality of data storage areas for storing the data; and
a plurality of encryption key management areas which store the first encryption key, and
each of the encryption key management areas stores the first encryption key to be used in each different data storage area.

4. The computer system according to claim 2,
wherein the storage device includes:
one or more data storage areas for storing the data; and
one or more encryption key management areas for storing the first encryption key,
a management computer is coupled to the storage controllers though a second network,
the management computer comprises:
a management interface coupled to the second network;
a third processor coupled to the management interface; and
a third memory coupled to the third processor,
the computer system holds information to identify each of the data storage areas included in the storage device and information to identify the storage controller authorized to access each of the data storage areas,
the third processor generates the second encryption key, and transmits the generated second encryption key to the storage controller based on the information to identify the storage controller authorized to access the data storage area, and
the second processor of at least one of the storage controllers encrypts the first encryption key by using the transmitted second encryption key.

5. The computer system according to claim 2,
wherein the storage device includes:
one or more data storage areas for storing the data; and
one or more encryption key management areas for storing the first encryption key,
a management computer is coupled to the storage controllers through a second network,
the management computer comprises:
a management interface coupled to the second network;
a third processor coupled to the management interface; and
a third memory coupled to the third processor,
the computer system holds information to identify each of the data storage areas included in the storage device and information to identify the storage controller authorized to access each of the data storage areas, and
when a first storage controller among the plurality of storage controllers authorized to access the data storage area is prohibited from accessing the data storage area, the second processor of a second storage controller still authorized to access the data storage area among the plurality of storage controllers decrypts data of the data storage area by using the first encryption key decrypted by using the second encryption key, generates a new first encryption key different from the first encryption key, and encrypts the decrypted data by using the new first encryption key.

6. The computer system according to claim 2,
wherein the storage device includes:
one or more data storage areas for storing the data; and
one or more encryption key management areas for storing the first encryption key,
a management computer is coupled to the storage controllers through a second network,
the management computer comprises:
a management interface coupled to the second network;
a third processor coupled to the management interface; and
a third memory coupled to the third processor,
the computer system holds information to identify each of the data storage areas included in the storage device and information to identify the storage controller authorized to access each of the data storage areas,
when a first storage controller among the plurality of storage controllers authorized to access the data storage area is prohibited from accessing the data storage area, the third processor generates a new second encryption key, and transmits the new second encryption key to a second storage controller still authorized to access the data storage area among the plurality of storage controllers, and
the second processor of the second storage controller encrypts the first encryption key by using the new second encryption key.

7. The computer system according to claim 2,
wherein the storage device includes:
one or more data storage areas for storing the data; and
a plurality of encryption key management areas for storing the first encryption key,
a management computer is coupled to the storage controllers through a second network,
the management computer comprises:
a management interface coupled to the second network;
a third processor coupled to the management interface; and
a third memory coupled to the third processor,
the computer system holds information to identify each of the data storage areas included in the storage device and information to identify the storage controller authorized to access each of the data storage areas,
when a first storage controller among the plurality of storage controllers authorized to access the data storage area is prohibited from accessing the data storage area, the third processor changes the key management area for storing the first encryption key to be used for the data storage area, and transmits information to identify the key management area after the change to a second storage controller still authorized to access the data storage area among the plurality of storage controllers, and
the second processor of the second storage controller moves the first encryption key to the key management area after the change.

8. A storage controller coupled to a host computer through a first network,
wherein the host computer comprises:
a first interface coupled to the first network;
a first processor coupled to the first interface; and
a first memory coupled to the first processor,
the storage controller comprises:
one or more second processors; and
one or more second memories coupled to the second processors, the storage controller being coupled to a storage device for storing data, and
the second processor
encrypts data by using a first encryption key upon reception of a writing request of the data from the host computer,
stores the encrypted data and the first encryption key in the storage device,
reads the encrypted data and the first encryption key from the storage device upon reception of a reading request of the data from the host computer, and
decrypts the encrypted data by using the read first encryption key.

9. The storage controller according to claim 8,
wherein the second processor
encrypts the first encryption key by using a second encryption key,
stores the encrypted first encryption key in the storage device,
decrypts the first encryption key read from the storage device by using the second encryption key, and
decrypts the encrypted data by using the decrypted first encryption key.

10. The storage controller according to claim 8,
wherein the storage device includes:
a plurality of data storage areas for storing the data; and
a plurality of encryption key management areas which store the first encryption key, and
the second processor stores the first encryption key to be used in each different data storage area in each of the encryption key management areas.

11. The storage controller according to claim 9,
wherein the storage device includes:
one or more data storage areas for storing the data; and
one or more encryption key management areas for storing the first encryption key;
the storage controller is coupled to a management computer though a second network,
the management computer comprises:
a management interface coupled to the second network;
a third processor coupled to the management interface; and
a third memory coupled to the third processor,
the storage controller holds information to identify each of the data storage areas included in the storage device and information to identify the storage controller authorized to access each of the data storage areas, and
the second processor encrypts the first encryption key by using the second encryption key transmitted from the management computer.

12. The storage controller according to claim 9,
wherein the storage device includes:
one or more data storage areas for storing the data; and
one or more encryption key management areas for storing the first encryption key;
the storage controller is coupled to a management computer through a second network,
the management computer comprises:
a management interface coupled to the second network;
a third processor coupled to the management interface; and
a third memory coupled to the third processor,
the storage controller holds information to identify each of the data storage areas included in the storage device and information to identify the storage controller authorized to access each of the data storage areas, and
when a first storage controller among the plurality of storage controllers authorized to access the data storage area is prohibited from accessing the data storage area, the second processor of a second storage controller still authorized to access the data storage area among the plurality of storage controllers decrypts data of the data storage area by using the first encryption key decrypted by using the second encryption key, generates a new first encryption key different from the first encryption key, and encrypts the decrypted data by using the new first encryption key.

13. The storage controller according to claim 9,
wherein the storage device includes:
one or more data storage areas for storing the data; and
one or more encryption key management areas for storing the first encryption key,
the storage controller is coupled to a management computer through a second network,
the management computer comprises:
a management interface coupled to the second network;
a third processor coupled to the management interface; and
a third memory coupled to the third processor,
the storage controller holds information to identify each of the data storage areas included in the storage device and information to identify the storage controller authorized to access each of the data storage areas, and
when a first storage controller among the plurality of storage controllers authorized to access the data storage area is prohibited from accessing the data storage area, the second processor of a second storage controller still authorized to access the data storage area among the plurality of storage controllers decrypts the first encryption key by using a second encryption key, and encrypts the first encryption key by using a new second encryption key transmitted from the management computer.

14. The storage controller according to claim 9,
wherein the storage device includes:
one or more data storage areas for storing the data; and
a plurality of encryption key management areas for storing the first encryption key,
the storage controller is coupled to a management computer through a second network,
the management computer comprises:
a management interface coupled to the second network;
a third processor coupled to the management interface; and
a third memory coupled to the third processor,
the storage controller holds information to identify each of the data storage areas included in the storage device and information to identify the storage controller authorized to access each of the data storage areas, and
when a first storage controller among the plurality of storage controllers authorized to access the data storage area is prohibited from accessing the data storage area, the second processor of a second storage controller still authorized to access the data storage area among the plurality of storage controllers moves the first encryption key to be used for the data storage area to a key management area relevant to identification information transmitted from the management computer.

15. A management computer for managing a computer system comprising one or more host computers and a plurality of storage controllers coupled to the host computer through a first network,
wherein the host computer comprises:
a first interface coupled to the first network;
a first processor coupled to the first interface; and
a first memory coupled to the first processor,
each of the storage controllers comprises:
one or more second processors; and
one or more second memories coupled to the second processors, the storage controllers each being coupled to a storage device for storing data,
the storage device includes one or more data storage areas for storing the data,
the management computer comprises:
a management interface coupled to a second network;
a third processor coupled to the management interface; and
a third memory coupled to the third processor,
the third memory holds information to identify each of the data storage areas included in the storage device and information to identify the storage controller authorized to access each of the data storage areas, and
the third processor generates a second encryption key to encrypt a first encryption key for decrypting data stored in the data storage area, and transmits the generated second encryption key to the storage controller authorized to access the data storage area.

16. The management computer according to claim 15, wherein when a first storage controller among the plurality of storage controllers authorized to access the data storage area is prohibited from accessing the data storage area, the third processor generates a new second encryption key, and transmits the new second encryption key to a second storage controller still authorized to access the data storage area among the plurality of storage controllers.

17. The management computer according to claim 15, wherein when a first storage controller among the plurality of storage controllers authorized to access the data storage area is prohibited from accessing the data storage area, the third processor changes a key management area for storing the first encryption key to be used for the data storage area, and transmits information to identify the key management area after the change to a second storage controller still authorized to access the data storage area among the plurality of storage controllers.
